(19) United States
(12) Patent Application Publication
(10) Pub. No.: US 2026/0185178 A1
(43) Pub. Date: Jul. 2, 2026

(54) ELECTRICAL STEEL SHEET WITH INSULATING COATING

(71) Applicant: JFE STEEL CORPORATION, Chiyoda-ku, Tokyo (JP)

(72) Inventors: Chuei WAKASUGI, Chiyoda-ku, Tokyo (JP); Naoki MURAMATSU, Chiyoda-ku, Tokyo (JP); Takeshi MATSUDA, Chiyoda-ku, Tokyo (JP)

(73) Assignee: JFE STEEL CORPORATION, Chiyoda-ku, Tokyo (JP)

(21) Appl. No.: 19/130,688

(22) PCT Filed: Nov. 29, 2023
(86) PCT No.: PCT/JP2023/042809

§ 371 Date: May 16, 2025

(30) Foreign Application Priority Data
Dec. 2, 2022 (JP) 2022-193789

(51) Int. Cl. C21D 8/1277; C22C 38/02; C22C 38/04; C22C 38/06; H01F 19/00; H01F 27/245; H02K 1/02; H02K 1/04

(52) U.S. Cl. CPC C21D 8/1283; C22C 38/02; C22C 38/04; C22C 38/06; H01F 27/245; H02K 1/02; H02K 1/04; H01F 19/00

(57) ABSTRACT

Provided is an electrical steel sheet with an insulating coating that suppresses cracking of the insulating coating after stress relief annealing and has excellent sticking resistance. The electrical steel sheet with an insulating coating includes an electrical steel sheet and an insulating coating formed on at least one surface of the electrical steel sheet. The insulating coating contains Zr and Mn, and a mass ratio Mn/Zr in the insulating coating is from 0.010 to 0.100.

### TECHNICAL FIELD

The present disclosure relates to an electrical steel sheet with an insulating coating.

### BACKGROUND

An insulating coating applied to an electrical steel sheet used for motors, transformers and the like is required to have various properties such as not only interlaminar resistance but also convenience during processing and molding, stability during storage and use, and so on. Particularly an insulating coating that has excellent punchability can decrease frequency of replacement of a press mold when punching. Electrical steel sheets are used in a variety of applications, and therefore various insulating coatings have been developed depending upon the application. When an electrical steel sheet is subjected to punching, shearing, bending, or the like, magnetic properties are degraded due to residual strain, and therefore stress relief annealing at a temperature of about 700° C. to 800° C. is often carried out to address this problem. In this case, therefore, the insulating coating must be resistant to the stress relief annealing.

Insulating coatings applied to electrical steel sheets are roughly classified into three types:
(1) Inorganic coating, placing great importance on weldability and heat resistance, and being resistant to stress relief annealing;
(2) Resin-containing inorganic coating, aimed at achieving both punchability and weldability, and achieving resistance to stress relief annealing (that is, semi-organic coating); and
(3) Organic coating, for special applications, which cannot be subjected to stress relief annealing.

Of these, only the coatings containing an inorganic component, types (1) and (2), are resistant to the stress relief annealing as general-purpose products, both of which typically contain a chromium compound. In particular, the chromium insulating coating of type (2), which is produced by a one-coat one-bake process, can remarkably improve punchability compared with a completely inorganic insulating coating, and is therefore widely used.

However, as environmental awareness is rising in recent years, chromate-free products that have an insulating coating free of chromium compound are in demand by consumers even in the field of electrical steel sheets. The following is a technique for forming an insulating coating of type (2) by applying a surface-treatment solution to the surface of an electrical steel sheet, where the surface-treatment solution contains both an organic component and an inorganic component, and does not contain any chromium compound.

Patent Literature (PTL) 1 describes “an electrical steel sheet with an insulating coating comprising an electrical steel sheet and an insulating coating formed on at least one surface of the electrical steel sheet, the insulating coating containing Zr and an organic resin, wherein the average primary particle size of the organic resin is 1.0 μm or less, the percentage of primary particles that are agglomerated particles in the primary particles of the organic resin is from 5% to 50%, and the total coating weight per surface of the insulating coating is from 0.1 g/m² to 1.5 g/m² (claim 1)”. The electrical steel sheet with an insulating coating of PTL 1 has excellent punchability and powdering resistance, without any chromium compound being contained in the insulating coating.

### CITATION LIST

### Patent Literature

PTL 1: JP 2017-160536 A

### SUMMARY

### Technical Problem

However, in a conventional electrical steel sheet with an insulating coating, such as that of PTL 1, there was a risk of cracks in the insulating coating after stress relief annealing. When cracks appear in the insulating coating, coating adhesion may degrade due to a decrease in bonding strength within the coating. When coating adhesion degrades due to a decrease in the bonding strength within the coating, the insulating coating may peel off, resulting in various problems.

Further, when sticking occurs between electrical steel sheets during stress relief annealing, an electrical short circuit is caused, which results in a problem of increased iron loss. Therefore, electrical steel sheets that have an insulating coating are required to not stick to each other during stress relief annealing, that is, to have excellent sticking resistance.

In view of the problems described above, it would be helpful to provide an electrical steel sheet with an insulating coating that suppresses cracking of the insulating coating after stress relief annealing and has excellent sticking resistance.

### Solution to Problem

The inventors have conducted extensive studies and discovered that, for insulating coatings containing Zr compounds, when the Mn in the insulating coating is within a certain range, in terms of a mass ratio Mn/Zr, the effects of suppressing cracking of the insulating coating after stress relief annealing and achieving excellent sticking resistance are obtainable.

The present disclosure was completed based on these discoveries, and primary features of the present disclosure are described below.
[1] An electrical steel sheet with an insulating coating, comprising an electrical steel sheet and an insulating coating formed on at least one surface of the electrical steel sheet, wherein
the insulating coating contains Zr and Mn, and a mass ratio Mn/Zr in the insulating coating is from 0.010 to 0.100.
[2] The electrical steel sheet with an insulating coating according to [1], above, wherein the insulating coating contains Si, and a mass ratio Si/Zr in the insulating coating is 1.5 or less.
[3] The electrical steel sheet with an insulating coating according to [1] or [2], above, wherein the insulating coating contains P, and a mass ratio P/Zr in the insulating coating is 1.5 or less.
[4] The electrical steel sheet with an insulating coating according to any one of [1] to [3], above, wherein the insulating coating contains organic resin, and a ratio of the organic resin mass %/ZrO₂ equivalent of Zr mass % in the insulating coating is 0.5 or less.
[5] A motor comprising an iron core formed by stacking the electrical steel sheet with an insulating coating according to any one of [1] to [4], above.
[6] A transformer comprising an iron core formed by stacking the electrical steel sheet with an insulating coating according to any one of [1] to [4], above.

### Advantageous Effect

The electrical steel sheet with an insulating coating according to the present disclosure suppresses cracking of the insulating coating after stress relief annealing and has excellent sticking resistance.

### DETAILED DESCRIPTION

The electrical steel sheet with an insulating coating according to an embodiment of the present disclosure includes an electrical steel sheet and an insulating coating formed on at least one surface of the electrical steel sheet.

### [Electrical Steel Sheet]

The electrical steel sheet (base steel sheet) that serves as the substrate for the insulating coating is not limited to any particular electrical steel sheet. An electrical steel sheet comprising a typical chemical composition may be used. Examples of typical components include Si, Mn, Al, and the like, with the balance being Fe and inevitable impurity. Normally, Si content is 0.05 mass % to 7.0 mass %, Mn content is 0.05 mass % to 10.0 mass %, and Al content is 2.0 mass % or less.

Further, the type of the electrical steel sheet is not particularly restricted. A typical cold-rolled steel sheet such as a soft iron sheet (electrical core sheet) that has a high magnetic flux density or an SPCC, a non-oriented electrical steel sheet containing Si or Al for increased specific resistance, or the like, may be used. Use of a non-oriented electrical steel sheet according to JIS C2552:2014 or a grain-oriented electrical steel sheet according to JIS C2553:2019 is preferred.

### [Insulating Coating]

According to the present embodiment, the insulating coating contains Zr and Mn, and optionally also contains one or more selected from the group consisting of Si, P, and organic resin. The following is a description of the components contained in the insulating coating.

The insulating coating containing Zr can be prepared by using a Zr compound as raw material. Examples of Zr compounds include zirconium acetate, zirconium oxide, zirconium propionate, zirconium oxychloride, zirconium nitrate, zirconium ammonium carbonate, zirconium potassium carbonate, zirconium hydroxychloride, zirconium sulfate, zirconium potassium hexafluoride, zirconium tetra-n-propoxy, zirconium tetra-n-butoxy, zirconium tetraacetylacetonate, zirconium tributoxyacetylacetonate, zirconium tributoxystearate, and the like. According to the present embodiment, one or more of these may be selected and used. Such Zr compounds have strong bonding strength with oxygen and can bond firmly with oxides, hydroxides, and the like on an electrical steel sheet surface. Further, Zr has the capacity for three or more bonds, and therefore can form a network among Zr or with other inorganic compounds to form a tough insulating coating without a chromium compound.

When the Zr compound coating weight (Zr content in the insulating coating) is 0.05 g/m² or more in ZrO₂ equivalent, corrosion resistance is improved on the grounds that the coating by ZrO₂ is sufficient. When the Zr compound coating weight (Zr content in the insulating coating) is 1.50 g/m² or less in ZrO₂ equivalent, the insulating coating is less likely to crack, resulting in good coating adhesion and corrosion resistance. Therefore, the coating weight (Zr content in the insulating coating) of the Zr compound is preferably adjusted to be 0.05 g/m² or more and 1.50 g/m² or less in ZrO₂ equivalent. The Zr compounds as raw materials are all considered to be ZrO₂ in the insulating coating. That is, Zr in the insulating coating is considered to exist as ZrO₂. For this reason, ZrO₂ equivalent is used as the Zr content in the insulating coating according to the present embodiment. The ZrO₂ equivalent, in g/m², can be obtained from the following formula.

$$Zr {O}_{2} equivalent ( g / {m}^{2} ) = coating weight ( g / {m}^{2} ) \times Zr {O}_{2} equivalent ( mass \% ) / 100$$

The coating weight is determined from the difference between the weight of the electrical steel sheet before the formation of the insulating coating and the weight of electrical steel sheet with the insulating coating. The coating weight is preferably 0.05 g/m² or more. The coating weight is preferably 1.50 g/m² or less. When the coating weight is 0.05 g/m² or more, corrosion resistance can be secured, and when the coating weight is 1.50 g/m² or less, coating adhesion can be secured.

The ZrO₂ equivalent, in mass %, is obtained by measuring the Zr content, in mass %, of the coating portion by energy dispersive X-ray spectroscopy (EDX) analysis using a transmission electron microscope, and converting this to the ZrO₂ equivalent, in mass %. It is desirable to analyze about ten points and use the average value.

An insulating coating containing Mn can be prepared by using a Mn compound as raw material. Examples of Mn compounds include MnO₂ and Mn₂O₃, and one or both of these can be used.

Here, according to the present embodiment, it is important that the mass ratio Mn/Zr in the insulating coating be from 0.010 to 0.100.

When the mass ratio Mn/Zr is 0.010 or more, the Mn content in the insulating coating is sufficient and cracking of the insulating coating after stress relief annealing is suppressed. It is not clear why cracking can be suppressed when the mass ratio Mn/Zr is 0.010 or more, but the inventors understand that high reactivity of the Zr compound with Mn may be the root cause. That is, when the mass ratio Mn/Zr is 0.010 or more, chemical reactions are more likely to occur in the insulating coating and bonds are formed between molecules, resulting in suppression of cracking.

On the other hand, when the mass ratio Mn/Zr exceeds 0.100, electrical steel sheets stick to each other during stress relief annealing, resulting in poor sticking resistance. This may be due to the high reactivity of the insulating coating applied on the electrical steel sheet, which forms new chemical bonds between stacked electromagnetic steel sheets, resulting in sticking. Therefore, from the viewpoint of obtaining excellent sticking resistance, the mass ratio Mn/Zr is 0.100 or less. The mass ratio Mn/Zr is more preferably 0.050 or less. Conventionally, stress relief annealing was often performed at temperatures of about 700° C. to 800° C. However, recently, in order to further improve magnetic properties, higher temperatures for stress relief annealing are being considered and stress relief annealing at a temperature of about 900° C. is being considered. According to the present embodiment, by setting the mass ratio Mn/Zr to 0.100 or less, a remarkable effect of excellent sticking resistance in stress relief annealing at a high temperature of 900° C. is achieved.

According to the present embodiment, from the viewpoint of improving insulation, the insulating coating may contain Si. An insulating coating containing Si can be prepared by using a Si compound as raw material. Examples of Si compounds include colloidal silica, fumed silica, alkoxysilane, siloxane, and the like, and one or more of these compounds may be selected and used. From the viewpoint of obtaining a sufficient effect of improving insulation, the mass ratio Si/Zr in the insulating coating is preferably 0.5 or more. From the viewpoint of suppressing a decrease in coating adhesion due to a decrease in bonding strength between the electrical steel sheet and the insulating coating, the mass ratio Si/Zr in the insulating coating is preferably 1.5 or less.

According to the present embodiment, from the viewpoint of improving corrosion resistance, the insulating coating may contain P. An insulating coating containing Si can be prepared by using a Si compound as raw material. Examples of P compounds include phosphoric acids such as orthophosphoric acid, anhydrous phosphoric acid, linear polyphosphoric acid, cyclic metaphosphoric acid, and phosphates such as ammonium phosphate, magnesium phosphate, aluminum phosphate, calcium phosphate, and zinc phosphate, and one or more of these may be selected and used. From the viewpoint of fully obtaining the effect of improving corrosion resistance, the mass ratio P/Zr in the insulating coating is preferably 0.5 or more. From the viewpoint of suppressing a decrease in coating adhesion due to a decrease in bonding strength between the electrical steel sheet and the insulating coating, the mass ratio P/Zr in the insulating coating is preferably 1.5 or less.

According to the present embodiment, the mass ratios Mn/Zr, Si/Zr, and P/Zr in the insulating coating are determined by the following method.

First, the mass ratio Mn/Zr in the insulating coating is measured by Auger electron spectroscopy. While ion sputtering, at least Mn, Zr, Si, P, Fe, O, and C are included in the measurement elements, and depth analysis is performed by Auger electron spectroscopy to create a depth profile converted to mass concentration from the signal intensity ratio of each element. When analyzing in the depth direction from the sputtering start point, the average mass concentrations of Mn and Zr are determined from the maximum mass concentration of Zr to a depth where the mass concentration is decreased to half, and the average Mn mass concentration is divided by the average Zr mass concentration to determine a value. The number of analysis points on the insulating coating is ten or more, and the average value of the average Mn mass concentration/average Zr mass concentration of all analysis points is the “mass ratio Mn/Zr” according to the present disclosure. The “insulating coating” is defined as the depth to which the mass concentration of Zr is decreased to half. Needless to say, the portion deeper than the location where the mass concentration of Zr is reduced to half is “electrical steel sheet”.

The mass ratio Si/Zr and the mass ratio P/Zr in the insulating coating are also measured in the same way by Auger electron spectroscopy. That is, the mass ratio Si/Zr and the mass ratio P/Zr can be determined by replacing the Mn mass concentration in the previous paragraph with Si mass concentration and P mass concentration, respectively.

According to the present embodiment, from the viewpoint of improving various coating performances such as corrosion resistance and punchability, the insulating coating may contain organic resin. There are no particular restrictions on organic resins, and any known resin may be used. Example organic resins include water-based resins (emulsions, dispersions, water soluble) such as acrylic resin, alkyd resin, polyolefin resin, styrene resin, vinyl acetate resin, epoxy resin, phenol resin, polyester resin, urethane resin, melamine resin, and the like, and one or more of these may be selected and used.

From the viewpoint of sufficiently improving coating performance, the ratio of organic resin mass %/ZrO₂ equivalent of Zr mass % in the insulating coating is preferably 0.05 or more. On the other hand, organic resins are more permeable to oxygen than Zr compounds, so an excess of organic resin degrades corrosion resistance. From this viewpoint, the organic resin mass %/ZrO₂ equivalent of Zr mass % in the insulating coating is preferably 0.5 or less.

The organic resin mass %/ZrO₂ equivalent of Zr mass % in the insulating coating is determined by the following method. EDX analysis using a transmission electron microscope is used to determine the C and Zr content, in mass %, of the coating portion. The C content, in mass %, is converted to organic resin content, in mass %, the Zr content, in mass %, is converted to ZrO₂ equivalent, in mass %, and the organic resin content, in mass %, is divided by the ZrO₂ equivalent, in mass %, to determine the ratio of organic resin mass %/ZrO₂ equivalent of Zr mass %. It is desirable to analyze about ten points and use the average value.

According to the present embodiment, the insulating coating preferably comprises a Zr compound as the Zr source, a Mn compound as the Mn source, optionally one or more selected from the group consisting of a Si compound as the Si source, a P compound as the P source, and an organic resin, and optionally other components as indicated below.

Further, the present embodiment does not preclude the inclusion of an inorganic compound such as a surfactant, a rust inhibitor, a lubricant, an antioxidant, and other additives normally used, such as boric acid, a pigment, and the like, and an organic compound, in addition to the components listed above. Here, as the organic compound, examples include an organic acid as a contact inhibitor between an inorganic component and an organic resin. The organic acid may be a polymer or a copolymer containing acrylic acid, or the like. The other components can be added to the extent that they do not impair the effects described. When the total solid content of the additives mass %/ZrO₂ equivalent mass % exceeds 1.0, unreacted materials remain in the coating and decrease water resistance. Therefore, the total solid content of the additives mass %/ZrO₂ equivalent mass % is 1.0 or less. The total solid content of the additives mass %/ZrO₂ equivalent mass % is preferably 0.5 or less.

According to the present embodiment, Hf, HfO₂, TiO₂, or the like may be mixed in as impurity in the inorganic components. As long as the total amount of these impurities is 5 mass % or less of the ZrO₂ equivalent, no particular problem occurs.

The method of producing an electrical steel sheet with an insulating coating is described below. Pretreatment for the electrical steel sheet is not particularly restricted. The electrical steel sheet may be untreated. It is advantageous to perform degreasing treatment such as alkali treatment, and pickling treatment with hydrochloric acid, sulfuric acid, phosphoric acid, or the like.

A coating solution for forming the insulating coating is then prepared. The coating solution is prepared by adding and mixing the Zr compound, the Mn compound, optionally one or more selected from the group consisting of the Si compound, the P compound, and the organic resin, and optionally any of the other components mentioned above, in deionized water.

The coating solution is then applied to the surface of the electrical steel sheet. The method of application is not particularly restricted. A most appropriate method according to the shape of the electrical steel sheet to be treated is selected, examples including a roll coating method, a bar coating method, a dip coating method, a spray coating method, and the like.

The coating solution applied to the electrical steel sheet is then baked and formed into an insulating coating. The baking method is not particularly restricted, and a common method such as a hot blast heating method, an infrared heating method, an induction heating method, or the like may be used. The peak metal temperature is not particularly restricted and may be in a range of about 150° C. to 350° C. The heating time is not particularly restricted, and may be appropriately set within a range from 1 s to 10 s.

Through the above process, an electrical steel sheet with an insulating coating can be produced according to the present embodiment.

The insulating coating is preferably formed on both surfaces of the electrical steel sheet. Depending on the intended purpose, the insulating coating according to the present embodiment may be formed on one surface of the electrical steel sheet, with or without another insulating coating formed on the other surface.

The electrical steel sheet with an insulating coating according to the present embodiment may be subjected to stress relief annealing to remove stress caused by punching, for example. Preferred stress relief annealing atmospheres include an N₂ atmosphere, a DX gas atmosphere, and other atmospheres where iron is less likely to be oxidized. Here, the corrosion resistance can be further improved by setting a high dew point, for example, a Dp of about 5° C. to 60° C. to slightly oxidize the surface and the cut end surfaces. Typically, the preferred stress relief annealing temperature is 700° C. to 900° C., more preferably 700° C. to 800° C., but stress relief annealing is possible even at 900° C. for insulating coating according to the present embodiment. Longer hold times at the stress relief annealing temperature are preferred. Hold time is more preferably one hour or more.

The motor according to an embodiment of the present disclosure comprises an iron core formed by stacking the electrical steel sheet with an insulating coating described above. The transformer according to an embodiment of the present disclosure comprises an iron core formed by stacking the electrical steel sheet with an insulating coating described above.

That is, the electrical steel sheet with an insulating coating according to the present embodiment is suitable for use in the rotor core of a interior permanent magnet motor (IPM motor), for example. In recent years, drive motors used in hybrid electric vehicles (HEV) and electric vehicles (EV) have been made to rotate at significantly higher speeds, and during high-speed rotation, strong centrifugal forces act on the bridge where a permanent magnet is embedded. The electrical steel sheet with an insulating coating according to the present embodiment is able to withstand such centrifugal forces. The application of the electrical steel sheet with an insulating coating according to the present embodiment is not limited to rotor cores, and can also be used for the iron core of a stator, for example.

The use of the same steel sheet with insulating coating as a member for a rotor core and a member for a stator core is advantageous from the viewpoint of yield, since an approximately circular region at the center of the member for the stator core, which is punched out in an approximately circular shape, can be used as the material of the member for the rotor core, and this type of sheet punching is commonly called “shared punching”.

Stress relief annealing is preferably applied to a member punched from a steel sheet with insulating coating for a stator core, or applied to a stator core formed by stacking same. High strength is not required for material for a stator core and low iron loss is important, and therefore it is appropriate to eliminate processing strain that has an adverse effect on iron loss.

Whether for a rotor core or a stator core, assuming shared punching, stress relief annealing is performed to remove the processing strain applied to the electrical steel sheet during punching of the steel sheet with insulating coating, and the electrical steel sheet that has good sticking resistance is obtainable according to the present disclosure.

The present disclosure is described in more detail using the examples below. However, the present disclosure is not limited to these examples.

### Examples

In each of the test cases listed in Table 1, the coating solution was prepared by adding the Zr compound, the Mn compound, and in some cases the Si compound, the P compound, or one of the organic resins, to deionized water, and mixing. In Table 1, reference signs Z1 to Z4 representing Zr compounds are detailed in Table 2, M1 and M2 representing Mn compounds are detailed in Table 3, S1 representing a Si compound is detailed in Table 4, P1 representing a P compound is detailed in Table 5, and R1 and R2 representing organic resins are detailed in Table 6. The solid content concentration of all components with respect to the amount of deionized water was 50 g/L.

For each test case, a test piece that had a width of 150 mm and a length of 300 mm was cut from an electrical steel sheet [A360 (JIS C 2552 (2000))] that had a thickness of 0.35 mm, coated on one surface with the coating solution using a roll coater, and baked in a hot-air baking oven at a peak metal temperature of 200° C. for 30 s. The coating was then allowed to naturally cool to room temperature to obtain an insulating coating with a coating weight of 0.50 g/m².

<ZrO₂ Equivalent Mass % and ZrO₂ Equivalent Mass Ratio>

EDX analysis using a transmission electron microscope was used to determine the Zr content, in mass %, of the coated portion, which was converted to ZrO₂ equivalent, in mass %. Zr reacts chemically when the insulating coating is baked onto the steel sheet, and all of the Zr in the insulating coating exists as ZrO₂. The Zr content is therefore calculated and considered to be ZrO₂ equivalent. Ten analysis points were used, and the average value is listed in Table 1 as “ZrO₂ equivalent (mass %)”. Further, the content, in mass %, of Z1 to Z4 in Table 1 is also the ZrO₂ equivalent, in mass %, of each Zr compound in the insulating coating, and was obtained by the same method. The ZrO₂ equivalent mass ratio was determined as ZrO₂ equivalent mass %/100 and is listed in Table 1.

<ZrO₂ Equivalent g/m^{2>}

The ZrO₂ equivalent in g/m² was determined by the previously described method and the values are listed in Table 1.

### <Content in Mass % of Mn Compounds, Si Compound, P Compound, and Organic Resins>

The M1 and M2 content in Table 1, in mass %, are the MnO₂ equivalent or Mn₂O₃ equivalent of Mn in the insulating coating. The Mn content, in mass %, of the coating portion was measured by EDX analysis using a transmission electron microscope, and this was converted to MnO₂ equivalent or Mn₂O₃ equivalent, in mass %.

The S1 content in Table 1, in mass %, is the SiO₂ equivalent of Si in the insulating coating. The Si content, in mass %, of the coating portion was measured by EDX analysis using a transmission electron microscope, and this was converted to SiO₂ equivalent, in mass %.

The P1 content in Table 1, in mass %, is the PO₄ equivalent of P in the insulating coating. The P content, in mass %, of the coating portion was measured by EDX analysis using a transmission electron microscope, and this was converted to PO₄ equivalent, in mass %.

The R1 and R2 content in Table 1, in mass %, are the organic resin content in the insulating coating, and are values calculated by measuring the C content, in mass %, of the coating portion by EDX analysis using a transmission electron microscope and converting this to the organic resin content, in mass %.

In every case, ten analysis points were used, and the average of the ten points was adopted. In the EDX analysis of the present Examples using the transmission electron microscope, the accelerating voltage was 200 kV in each case.

### <Mn/Zr, Si/Zr, and P/Zr Mass Ratios>

Analysis was performed using an Auger electron spectrometer (produced by Physical Electronics, Inc.) at an accelerating voltage of 10 kV and a sample current of 0.2 μA. Depth analysis was performed at a sputter rate of 3 nm/min (value for ZrO₂) and measurements were taken every 2 min until the Zr count reached noise level. Based on the results of this analysis, the mass ratios Mn/Zr, Si/Zr, and P/Zr were calculated using the previously described method, and the respective values are listed in Table 1.

### <Organic Resin Mass %/ZrO₂ Equivalent of Zr Mass %>

Organic resin mass %/ZrO₂ equivalent of Zr mass % was determined by the previously described method, and the values are listed in Table 1.

The electrical steel sheet with an insulating coating obtained for each test case was subjected to the following evaluations, and the results are listed in Table 1.

### <Cracks in Insulating Coating>

Using a scanning electron microscope (Ultra Plus, produced by Carl Zeiss AG), the surface of the insulating coating was observed at an accelerating voltage of 5 kV to determine the presence of cracks in the insulating coating. Magnification during observation was 1000×. ⊚ or ◯ indicates an acceptable result.

### (Criteria)

⊚: no cracks
◯: cracks in some portions
x: cracks on all surfaces

### <Sticking Resistance>

Ten 50 mm square test pieces were stacked and annealed at 900° C. for 2 h under a nitrogen atmosphere while applying a load of 20 kPa (200 g/cm²). Then, a 500 g weight was dropped on the test pieces, and the height of the drop when the ten stuck test pieces divided into five was measured. The lower the drop height, the better the sticking resistance, or indicates an acceptable result.

### (Criteria)

⊚: 10 cm or less
◯: more than 10 cm, 15 cm or less
Δ: more than 15 cm, 30 cm or less
x: more than 30 cm

### <Adhesion>

Sellotape® (Sellotape is a registered trademark in Japan, other countries, or both) was applied to the surface of the test material, and the test material was bent inward to a 10 mm diameter, after which the Sellotape was peeled off and the remaining state of the insulating coating was observed to evaluate the adhesion of the insulating coating to the electrical steel sheet. ⊚ or ◯ indicates an acceptable result.

### (Criteria)

⊚: 90% or more remained
◯: 60% or more, less than 90% remained
Δ: 30% or more, less than 60% remained
x: less than 30% remained

### <Corrosion Resistance>

A wet test (50° C., relative humidity≥98%) was conducted on the test material, and the red rust ratio was observed after 2 weeks and evaluated by area fraction. ⊚ or ◯ indicates an acceptable result.

### (Criteria)

⊚: red rust area fraction less than 20%
◯: red rust area fraction 20% or more, less than 40%
Δ: red rust area fraction 40% or more, less than 60%
x: red rust area fraction 60% or more

TABLE 1

| | Composition of insulating coating | | | | | | | | | | | | | |
|---|---|---|---|---|---|---|---|---|---|---|---|---|---|---|
| | Inorganic compounds | | | | | | | | | | | | | |
| | | | | | | | | | | | Si compound | | P compound | |
| | Zr compounds Table 2 | | | | | | | | | | Table 4 | | Table 5 | |
| | Z1 | Z2 | Z3 | Z4 | ZrO₂ | ZrO₂ | ZrO₂ | Mn compounds Table 3 | | | | Si/Zr | | P/Zr |
| | mass | mass | mass | mass | equivalent | equivalent | equivalent | M1 | M2 | Mn/Zr | S1 | mass | P1 | mass |
| No. | % | % | % | % | g/m² | mass % | mass ratio | mass % | mass % | mass ratio | mass % | ratio | mass % | ratio |
| 1 | 99.5 | | | | 0.50 | 99.5 | 0.995 | 0.5 | | 0.004 | | | | |
| 2 | 98 | | | | 0.49 | 98.0 | 0.980 | 2 | | 0.017 | | | | |
| 3 | 95 | | | | 0.48 | 95.0 | 0.950 | 5 | | 0.045 | | | | |
| 4 | 90 | | | | 0.45 | 90.0 | 0.900 | 10 | | 0.095 | | | | |
| 5 | 80 | | | | 0.40 | 80.0 | 0.800 | 20 | | 0.213 | | | | |
| 6 | 99.5 | | | | 0.50 | 99.5 | 0.995 | | 0.5 | 0.005 | | | | |
| 7 | 98 | | | | 0.49 | 98.0 | 0.980 | | 2 | 0.019 | | | | |
| 8 | 95 | | | | 0.48 | 95.0 | 0.950 | | 5 | 0.049 | | | | |
| 9 | 90 | | | | 0.45 | 90.0 | 0.900 | | 10 | 0.104 | | | | |
| 10 | 80 | | | | 0.40 | 80.0 | 0.800 | | 20 | 0.235 | | | | |
| 11 | | 99.5 | | | 0.50 | 99.5 | 0.995 | 0.5 | | 0.004 | | | | |
| 12 | | 98 | | | 0.49 | 98.0 | 0.980 | 2 | | 0.017 | | | | |
| 13 | | 95 | | | 0.48 | 95.0 | 0.950 | 5 | | 0.045 | | | | |
| 14 | | 90 | | | 0.45 | 90.0 | 0.900 | 10 | | 0.095 | | | | |
| 15 | | 80 | | | 0.40 | 80.0 | 0.800 | 20 | | 0.213 | | | | |
| 16 | | 99.5 | | | 0.50 | 99.5 | 0.995 | | 0.5 | 0.005 | | | | |
| 17 | | 98 | | | 0.49 | 98.0 | 0.980 | | 2 | 0.019 | | | | |
| 18 | | 95 | | | 0.48 | 95.0 | 0.950 | | 5 | 0.049 | | | | |
| 19 | | 90 | | | 0.45 | 90.0 | 0.900 | | 10 | 0.104 | | | | |
| 20 | | 80 | | | 0.40 | 80.0 | 0.800 | | 20 | 0.235 | | | | |
| 21 | | | 99.5 | | 0.50 | 99.5 | 0.995 | 0.5 | | 0.004 | | | | |
| 22 | | | 98 | | 0.49 | 98.0 | 0.980 | 2 | | 0.017 | | | | |
| 23 | | | 95 | | 0.48 | 95.0 | 0.950 | 5 | | 0.045 | | | | |
| 24 | | | 90 | | 0.45 | 90.0 | 0.900 | 10 | | 0.095 | | | | |
| 25 | | | 80 | | 0.40 | 80.0 | 0.800 | 20 | | 0.213 | | | | |
| 26 | | | 99.5 | | 0.50 | 99.5 | 0.995 | | 0.5 | 0.005 | | | | |
| 27 | | | 98 | | 0.49 | 98.0 | 0.980 | | 2 | 0.019 | | | | |
| 28 | | | 95 | | 0.48 | 95.0 | 0.950 | | 5 | 0.049 | | | | |
| 29 | | | 90 | | 0.45 | 90.0 | 0.900 | | 10 | 0.104 | | | | |
| 30 | | | 80 | | 0.40 | 80.0 | 0.800 | | 20 | 0.235 | | | | |
| 31 | | | | 99.5 | 0.50 | 99.5 | 0.995 | 0.5 | | 0.004 | | | | |
| 32 | | | | 98 | 0.49 | 98.0 | 0.980 | 2 | | 0.017 | | | | |
| 33 | | | | 95 | 0.48 | 95.0 | 0.950 | 5 | | 0.045 | | | | |
| 34 | | | | 90 | 0.45 | 90.0 | 0.900 | 10 | | 0.095 | | | | |
| 35 | | | | 80 | 0.40 | 80.0 | 0.800 | 20 | | 0.213 | | | | |
| 36 | | | | 99.5 | 0.50 | 99.5 | 0.995 | | 0.5 | 0.005 | | | | |
| 37 | | | | 98 | 0.49 | 98.0 | 0.980 | | 2 | 0.019 | | | | |
| 38 | | | | 95 | 0.48 | 95.0 | 0.950 | | 5 | 0.049 | | | | |
| 39 | | | | 90 | 0.45 | 90.0 | 0.900 | | 10 | 0.104 | | | | |
| 40 | | | | 80 | 0.40 | 80.0 | 0.800 | | 20 | 0.235 | | | | |
| 41 | 40 | | | | 0.20 | 40.0 | 0.400 | 2 | | 0.043 | 58 | 0.92 | | |
| 42 | 35 | | | | 0.18 | 35.0 | 0.350 | 2 | | 0.049 | 63 | 1.14 | | |
| 43 | 30 | | | | 0.15 | 30.0 | 0.300 | 2 | | 0.057 | 68 | 1.43 | | |
| 44 | 25 | | | | 0.13 | 25.0 | 0.250 | 2 | | 0.068 | 73 | 1.84 | | |
| 45 | 20 | | | | 0.10 | 20.0 | 0.200 | 2 | | 0.085 | 78 | 2.46 | | |
| 46 | 30 | | | | 0.15 | 30.0 | 0.300 | 2 | | 0.057 | | | 68 | 0.66 |
| 47 | 25 | | | | 0.13 | 25.0 | 0.250 | 2 | | 0.068 | | | 73 | 0.85 |
| 48 | 20 | | | | 0.10 | 20.0 | 0.200 | 2 | | 0.085 | | | 78 | 1.14 |
| 49 | 15 | | | | 0.08 | 15.0 | 0.150 | 2 | | 0.114 | | | 83 | 1.62 |
| 50 | 10 | | | | 0.05 | 10.0 | 0.100 | 2 | | 0.171 | | | 88 | 2.57 |
| 51 | 90 | | | | 0.45 | 90.0 | 0.900 | 2 | | 0.019 | | | | |
| 52 | 80 | | | | 0.40 | 80.0 | 0.800 | 2 | | 0.021 | | | | |
| 53 | 70 | | | | 0.35 | 70.0 | 0.700 | 2 | | 0.024 | | | | |
| 54 | 60 | | | | 0.30 | 60.0 | 0.600 | 2 | | 0.028 | | | | |
| 55 | 50 | | | | 0.25 | 50.0 | 0.500 | 2 | | 0.034 | | | | |
| 56 | 90 | | | | 0.45 | 90.0 | 0.900 | 2 | | 0.019 | | | | |
| 57 | 80 | | | | 0.40 | 80.0 | 0.800 | 2 | | 0.021 | | | | |
| 58 | 70 | | | | 0.35 | 70.0 | 0.700 | 2 | | 0.024 | | | | |
| 59 | 60 | | | | 0.30 | 60.0 | 0.600 | 2 | | 0.028 | | | | |
| 60 | 50 | | | | 0.25 | 50.0 | 0.500 | 2 | | 0.034 | | | | |
| 61 | 49 | | 49 | | 0.49 | 98.0 | 0.980 | 2 | | 0.017 | | | | |
| 62 | 49 | 49 | | | 0.49 | 98.0 | 0.980 | 2 | | 0.017 | | | | |
| 63 | | 49 | | 49 | 0.49 | 98.0 | 0.980 | 2 | | 0.017 | | | | |
| 64 | | 49 | 49 | | 0.49 | 98.0 | 0.980 | 2 | | 0.017 | | | | |
| 65 | | | 49 | 49 | 0.49 | 98.0 | 0.980 | 2 | | 0.017 | | | | |
| | Composition of | | | | | | | | | | | | | |
| | insulating coating | | | | | | | | | | | | | |
| | Organic compounds | | | | | | | | | | | | | |
| | Organic resins Table 6 | | | | | | | | | | | | | |
| | | | Organic | | | | | | | | | | | |
| | | | resin | | | | | | | | | | | |
| | | | (mass %)/ | | | | | | | | | | | |

| | | | |
|---|---|---|---|
| R1 | R2 | ZrO₂ | Coating properties |

| | | | | |
|---|---|---|---|---|
| mass | mass | (mass %) | Sticking | Corrosion |

| No. | % | % | Ratio | Cracking | resistance | Adhesion | resistance | Classification |
|---|---|---|---|---|---|---|---|---|
| 1 | | | | X | ⊚ | ⊚ | ⊚ | Comparative Example |
| 2 | | | | ⊚ | ⊚ | ⊚ | ⊚ | Example |
| 3 | | | | ⊚ | ⊚ | ⊚ | ⊚ | Example |
| 4 | | | | ⊚ | ◯ | ⊚ | ⊚ | Example |
| 5 | | | | ⊚ | X | ⊚ | ⊚ | Comparative Example |
| 6 | | | | X | ⊚ | ⊚ | ⊚ | Comparative Example |
| 7 | | | | ⊚ | ⊚ | ⊚ | ⊚ | Example |
| 8 | | | | ⊚ | ⊚ | ⊚ | ⊚ | Example |
| 9 | | | | ⊚ | X | ⊚ | ⊚ | Comparative Example |
| 10 | | | | ⊚ | X | ⊚ | ⊚ | Comparative Example |
| 11 | | | | X | ⊚ | ⊚ | ⊚ | Comparative Example |
| 12 | | | | ⊚ | ⊚ | ⊚ | ⊚ | Example |
| 13 | | | | ⊚ | ⊚ | ⊚ | ⊚ | Example |
| 14 | | | | ⊚ | ◯ | ⊚ | ⊚ | Example |
| 15 | | | | ⊚ | X | ⊚ | ⊚ | Comparative Example |
| 16 | | | | X | ⊚ | ⊚ | ⊚ | Comparative Example |
| 17 | | | | ⊚ | ⊚ | ⊚ | ⊚ | Example |
| 18 | | | | ⊚ | ⊚ | ⊚ | ⊚ | Example |
| 19 | | | | ⊚ | X | ⊚ | ⊚ | Comparative Example |
| 20 | | | | ⊚ | X | ⊚ | ⊚ | Comparative Example |
| 21 | | | | X | ⊚ | ⊚ | ⊚ | Comparative Example |
| 22 | | | | ⊚ | ⊚ | ⊚ | ⊚ | Example |
| 23 | | | | ⊚ | ⊚ | ⊚ | ⊚ | Example |
| 24 | | | | ⊚ | ◯ | ⊚ | ⊚ | Example |
| 25 | | | | ⊚ | X | ⊚ | ⊚ | Comparative Example |
| 26 | | | | X | ⊚ | ⊚ | ⊚ | Comparative Example |
| 27 | | | | ⊚ | ⊚ | ⊚ | ⊚ | Example |
| 28 | | | | ⊚ | ⊚ | ⊚ | ⊚ | Example |
| 29 | | | | ⊚ | X | ⊚ | ⊚ | Comparative Example |
| 30 | | | | ⊚ | X | ⊚ | ⊚ | Comparative Example |
| 31 | | | | X | ⊚ | ⊚ | ⊚ | Comparative Example |
| 32 | | | | ⊚ | ⊚ | ⊚ | ⊚ | Example |
| 33 | | | | ⊚ | ⊚ | ⊚ | ⊚ | Example |
| 34 | | | | ⊚ | ◯ | ⊚ | ⊚ | Example |
| 35 | | | | ⊚ | X | ⊚ | ⊚ | Comparative Example |
| 36 | | | | X | ⊚ | ⊚ | ⊚ | Comparative Example |
| 37 | | | | ⊚ | ⊚ | ⊚ | ⊚ | Example |
| 38 | | | | ⊚ | ⊚ | ⊚ | ⊚ | Example |
| 39 | | | | ⊚ | X | ⊚ | ⊚ | Comparative Example |
| 40 | | | | ⊚ | X | ⊚ | ⊚ | Comparative Example |
| 41 | | | | ⊚ | ⊚ | ⊚ | ⊚ | Example |
| 42 | | | | ⊚ | ⊚ | ⊚ | ⊚ | Example |
| 43 | | | | ⊚ | ⊚ | ⊚ | ⊚ | Example |
| 44 | | | | ⊚ | ⊚ | ◯ | ⊚ | Example |
| 45 | | | | ⊚ | ⊚ | ◯ | ⊚ | Example |
| 46 | | | | ⊚ | ⊚ | ⊚ | ⊚ | Example |
| 47 | | | | ⊚ | ⊚ | ⊚ | ⊚ | Example |
| 48 | | | | ⊚ | ⊚ | ⊚ | ⊚ | Example |
| 49 | | | | ⊚ | X | ◯ | ⊚ | Comparative Example |
| 50 | | | | ⊚ | X | ◯ | ⊚ | Comparative Example |
| 51 | 8 | | 0.09 | ⊚ | ⊚ | ⊚ | ⊚ | Example |
| 52 | 18 | | 0.23 | ⊚ | ⊚ | ⊚ | ⊚ | Example |
| 53 | 28 | | 0.40 | ⊚ | ⊚ | ⊚ | ⊚ | Example |
| 54 | 38 | | 0.63 | ⊚ | ⊚ | ⊚ | ◯ | Example |
| 55 | 48 | | 0.96 | ⊚ | ⊚ | ⊚ | ◯ | Example |
| 56 | | 8 | 0.09 | ⊚ | ⊚ | ⊚ | ⊚ | Example |
| 57 | | 18 | 0.23 | ⊚ | ⊚ | ⊚ | ⊚ | Example |
| 58 | | 28 | 0.40 | ⊚ | ⊚ | ⊚ | ⊚ | Example |
| 59 | | 38 | 0.63 | ⊚ | ⊚ | ⊚ | ◯ | Example |
| 60 | | 48 | 0.96 | ⊚ | ⊚ | ⊚ | ◯ | Example |
| 61 | | | | ⊚ | ⊚ | ⊚ | ⊚ | Example |
| 62 | | | | ⊚ | ⊚ | ⊚ | ⊚ | Example |
| 63 | | | | ⊚ | ⊚ | ⊚ | ⊚ | Example |
| 64 | | | | ⊚ | ⊚ | ⊚ | ⊚ | Example |
| 65 | | | | ⊚ | ⊚ | ⊚ | ⊚ | Example |

TABLE 2

| Ref. sign | Name | Chemical formula | Manufacturer | Trade name |
|---|---|---|---|---|
| Z1 | Zirconium ammonium carbonate | (NH₄)₂{ZrO(CO₃)₂} | Daiichi Kigenso Kagaku Kogyo Co., Ltd. | Zircosol AC-20 |
| Z2 | Zirconium potassium carbonate | K₂{Zr(CO₃)₂(OH)₂)} | Nippon Light Metal Co., Ltd. | Zirmel 1000 |
| Z3 | Zirconium acetate | ZrO(C₂H₃O₂)₂ | Daiichi Kigenso Kagaku Kogyo Co., Ltd. | Zircosol ZA-20 |
| Z4 | Zirconium oxide | ZrO₂ | Wako Pure Chemical Industries, Ltd | Zirconium oxide (IV) |

TABLE 3

| Ref. sign | Name |
|---|---|
| M1 | MnO₂ |
| M2 | Mn₂O₃ |

TABLE 4

| Ref. sign | Manufacturer | Classification | Trade name |
|---|---|---|---|
| S1 | Nissan Chemical Corporation | Colloidal silica | Snowtex O |

TABLE 5

| Ref. sign | Name | Chemical formula |
|---|---|---|
| P1 | Ammonium phosphate | (NH₄)₃PO₄ |

TABLE 6

| Ref. sign | Name | Manufacturer | Trade name |
|---|---|---|---|
| R1 | Polyester resin | Toyobo Co., Ltd. | Vylonal MD1200 |
| R2 | Acrylic resin | DIC | Voncoat CP6140 |

### INDUSTRIAL APPLICABILITY

The electrical steel sheet with an insulating coating according to the present disclosure suppresses cracking of the insulating coating after stress relief annealing and has excellent sticking resistance, and is therefore extremely applicable to components such as motors and transformers.

1. An electrical steel sheet with an insulating coating,
comprising an electrical steel sheet and an insulating coating formed on at least one surface of the electrical steel sheet, wherein
the insulating coating contains Zr and Mn, and a mass ratio Mn/Zr in the insulating coating is from 0.010 to 0.100.

2. The electrical steel sheet with an insulating coating according to claim 1, wherein the insulating coating contains Si, and a mass ratio Si/Zr in the insulating coating is 1.5 or less.

3. The electrical steel sheet with an insulating coating according to claim 1, wherein the insulating coating contains P, and a mass ratio P/Zr in the insulating coating is 1.5 or less.

4. The electrical steel sheet with an insulating coating according to claim 1, wherein the insulating coating contains organic resin, and a ratio of the organic resin mass %/ZrO₂ equivalent of Zr mass % in the insulating coating is 0.5 or less.

5. A motor comprising an iron core formed by stacking the electrical steel sheet with an insulating coating according to claim 1.

6. A transformer comprising an iron core formed by stacking the electrical steel sheet with an insulating coating according to claim 1.

7. The electrical steel sheet with an insulating coating according to claim 2, wherein the insulating coating contains P, and a mass ratio P/Zr in the insulating coating is 1.5 or less.

8. The electrical steel sheet with an insulating coating according to claim 2, wherein the insulating coating contains organic resin, and a ratio of the organic resin mass %/ZrO₂ equivalent of Zr mass % in the insulating coating is 0.5 or less.

9. The electrical steel sheet with an insulating coating according to claim 3, wherein the insulating coating contains organic resin, and a ratio of the organic resin mass %/ZrO₂ equivalent of Zr mass % in the insulating coating is 0.5 or less.

10. The electrical steel sheet with an insulating coating according to claim 7, wherein the insulating coating contains organic resin, and a ratio of the organic resin mass %/ZrO₂ equivalent of Zr mass % in the insulating coating is 0.5 or less.
